(19) United States
(12) Patent Application Publication
(10) Pub. No.: US 2010/0024025 A1
(43) Pub. Date: Jan. 28, 2010

(54) AUTHENTICATION SYSTEM AND AUTHENTICATION SERVER DEVICE

(75) Inventors: Hiroshi YOSHIDA, Kawasaki (JP); Takuro SAITO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/463,465

(22) Filed: May 11, 2009

(30) Foreign Application Priority Data
Jul. 25, 2008 (JP) 2008-192703

(51) Int. Cl. H04L 9/32

(52) U.S. Cl. 726/9

(57) ABSTRACT

An account management server, when a device executing a service receives a card ID read from an ID card, sends back log-on data as a response, which is recorded in an account management DB in a way that associates the log-on data with the card ID. A user terminal, when reading the card ID from the ID card, transmits the card ID together with an account name of a user to an account management server. The account management server overwrites, with the received card ID, the card ID registered in the account management DB in a way that associates the card ID with the received account name or password.

### CROSS-REFERENCE TO RELATED APPLICATIONS

This application is based upon and claims the benefit of prior Japanese Patent Application No. 2008-192703 filed on Jul. 25, 2008, the entire contents of which are incorporated herein by reference.

### FIELD

The embodiment discussed herein is related to an authentication system which conducts individual authentication.

### BACKGROUND

Over the recent years, there has been developed and utilized an IC-card-based ID card which employs information retained within an IC chip embedded into the card for authentication of a variety of services. Utilized also is a mobile phone given the same function as that of the ID card by loading an SIM (Subscriber Identity Module) card having the built-in IC chip described above. On the other hand, a USB authentication key, which is configured by encrypting and storing the same ID into the IC chip within a USB memory, is also utilized.

These mediums are employed for a variety of applications. One of these applications is an exemplification of individual authentication conducted for such a propose that a server on the side of a service provider makes the authentication about whether a possessor of the medium is a valid recipient of a certain service or not, and, if the authentication gets successful, the service is provided to the medium possessor, and so on. The individual authentication such as this is carried out for, e.g., authenticating the identity when opening and closing a security gate, authenticating the identity in a credit card service, and authenticating an authorized person who receives a variety of network services and application services on a personal computer. The medium used for such a type of individual authentication will hereinafter be referred to as an authentication device.

According to the authentication system using the authentication device, items of identifying information (card ID, account name, password, etc) written to the IC chip in the authentication device are read via an antenna or a terminal provided in the device which executes the authentication target service, then attached with a password and biometric information inputted through an input device of the service execution device as the necessity may arise, and transmitted to the server.

Then, the server collates these items of received information with information about the authorized authentication device registered beforehand in a database, then authenticates that the authentication device is a formally-issued device and an account of its possessor is previously registered for the service, and, if the authentication gets successful, sends back the authentication result as a response to the device executing the authentication target service.

Then, the device receiving the authentication result executes the authentication target service.

[Patent document 1] Japanese Patent Laid-Open Publication No. 2007-34891
[Patent document 2] Japanese Patent Laid-Open Publication No. 2003-58656

With respect to the service utilizing such an authentication system, if the user loses the authentication device stored with the associated account, the user must notify the service provider and receive re-issuance of the authentication device. Especially when the user loses the authentication device while visiting a place other than a home ground for living such as a business trip, the user can not make a direct request for the re-issuance by going to a window of the service provider. Besides, if he or she makes request for the re-issuance online or by phone, he or she does not necessarily receive the reissued authentication device with certainty unless the user stays in the same lodging facilities. Further, even if he or she is able to receive the authentication device, a relatively long period of time is required, resulting eventually in occurrence of a delay in implementation of the operation.

What is proposed as a temporary technique thus enabling the authentication to be done even if the authentication device is lost in a remote place (which connotes a place other than the window of the service provider) is a method of issuing by e-mail a password (termed a “one-time password” in the sense that this password is invalidated for ensuring the security after being used once for the authentication) usable for only the authentication each time the authentication is conducted, and authenticating the identity by use of this one-time password.

The identity authentication using the one-time password, however, must involve issuing the one-time password for every authentication and is inferior to a greater degree than that normally using the authentication device. Besides, such a problem arises that whether the identity authentication based on the one-time password is conducted or not depends on each individual service provider, and hence all of the services can not be necessarily utilized based on the one-time password. Moreover, the one-time password should be issued for every service in order to keep the security, however, if done so, it follows that the usability further declines.

On the other hand, if the authentication device is lost, it is required that the lost authentication device is not abused for an unlawful access by the unauthorized third party. In this point, Japanese Patent Laid-Open Publication No. 2007-34891 discloses a solution for this problem but does not solve a problem of how the usability of the user is restored. Moreover, Japanese Patent Laid-Open Publication No. 2003-58656 discloses a method of making a procedure for updating the ID card from the remote place by utilizing network infrastructures such as the Internet, but does not provide any solution about the time till the user receives the reissued ID card after being updated.

### SUMMARY

According to an aspect of the embodiment, an authentication system include an authentication server device authenticating an identity based on unique device identifying information received from an authentication terminal capable of reading the unique device identifying information from an authentication device and a user terminal. The user terminal includes a reading section which reads a unique device identifying information from said authentication device, an individual identifying information acquiring section which acquires individual identifying information of a user, and a transmitting section which transmits update information containing the device identifying information and the individual identifying information to the authentication server device. The authentication server device includes a storage device stored with the individual identifying information and the device identifying information in a way that these items of information are associated with each other and an update section which updates, with the device identifying information in the update information, the device identifying information stored in said storage device in the way of being associated with the individual identifying information in the update information received from the user terminal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a block diagram of a network system building up an individual authentication system.

FIG. 2 is a block diagram showing correlations between respective functions as components of the individual authentication system.

FIG. 3 is a table showing a data structure of an account management database.

FIG. 4 is a flowchart showing processes based on a user information setting program and a server management system program.

FIG. 5 is a diagram showing a main UI screen.

FIG. 6 is a diagram showing a card change UI screen.

FIG. 7 is a diagram showing a card change execution UI screen.

FIG. 8 is a diagram showing a result UI screen in the case of receiving an update result.

### DESCRIPTION OF EMBODIMENT

The embodiment, which will hereinafter be discussed, is an exemplification that an authentication device in an authentication system according to the present invention is a non-contact type ID card, services authenticated by this ID card are categorized into an application service, a WEB service and a network service, and a single personal computer serves as both of an authentication terminal and a user terminal on which the service is executed.

### <System Architecture>

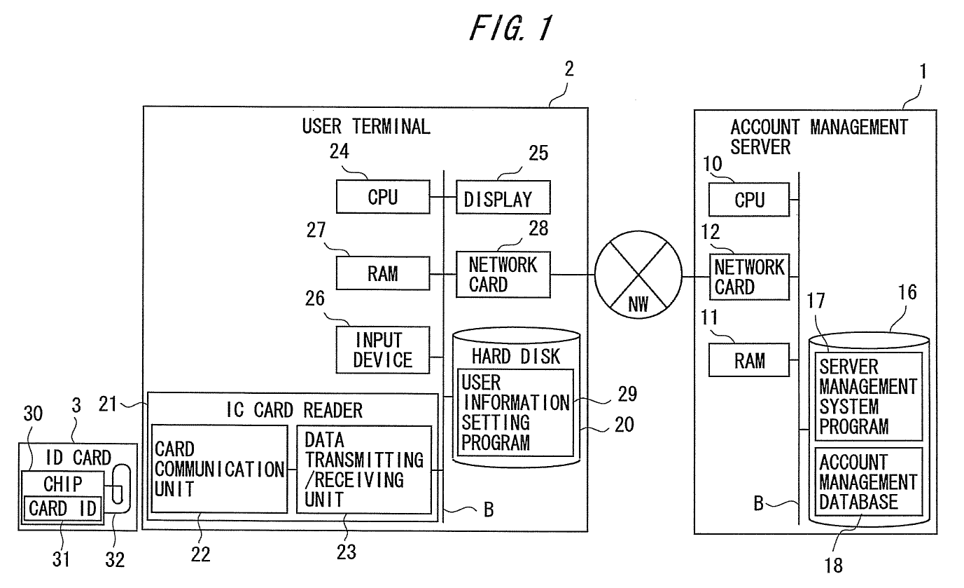

FIG. 1 is a block diagram showing an outline of an architecture of a network system configuring the authentication system according to the embodiment. As illustrated in FIG. 1, the network system is configured by a single account management server 1 (corresponding to an authentication server device) and a plurality of user terminals 2 (of which only one terminal is depicted in FIG. 1), which are connected to each other via a network NW.

To begin with, the network NW may be the Internet utilizable by the general public with high accessibility and may also be a membership personal computer network.

The ID card 3 serving as the authentication device is a plastic card into which a circuit chip 30 integrated with an electronic circuit and an antenna 32 are embedded, and is exemplified such as FeliCa (the registered trademark of Sony Corp.) developed by Sony Corp. The antenna 32 is a coil having a function of transmitting and receiving radio waves and a function of generating an electric current within an AC magnetic field and supplying the electric current to the circuit chip 30. Further, the circuit chip 30 includes a ROM area 31 which retains a unique card ID (corresponding to unique device identifying information), and has a function of reading the card ID from the ROM area 31 in response to a card ID readout command received via the antenna 32 and transmitting the card ID from the antenna 32.

Each user terminal 2 is a so-called personal computer operated by each individual user who signed a contract about a variety of services with a service provider. The user terminal 2 is a computer having a normal configuration including a network connecting function, and is constructed of main components such as a CPU 24, a display 25, an input device 26, a RAM (Random Access Memory) 27, a network card 28, an IC card reader 21 and a hard disk 20, which are connected to each other via a bus B.

The CPU 24 is a central processing unit which reads a program and executes processes based on the program.

The RAM 27 is a main storage device on which the program is read from the hard disk 20 and an operation area used for the CPU 24 to execute the processes is developed.

The network card 28 is a communication device (corresponding to transmitting section) which terminates the network NW and controls data communications with the network NW.

The display 25 is a device for displaying a processing result by the CPU 24.

The input device 26 includes a variety of input devices such as a keyboard and a pointing device like a mouse (corresponding to individual identifying information reading section).

The hard disk 20 is a storage device stored with an unillustrated operating system (OS), a variety of application programs for performing various types of services requiring log-on information, a variety of programs such as a WEB Browser program and various items of data. The variety of programs stored in the hard disk 20 include a user information setting program 29 for executing an individual authenticating process in order to link up with the account management server 1.

The IC card reader 21 is a device which reads a card ID from the ID card 3 by performing non-contact type communications with the ID card 3 and inputs the card ID to the CPU 24, and includes a card communication unit 22 and a data transmitting/receiving unit 23 (corresponding to reading section). The data transmitting/receiving unit 23 is an input/output interface with the bus B. Further, the card communication unit 22 is a wireless communication device which generates the AC magnetic field for supplying the power to the ID card 3, transmits the card ID readout command received from the CPU 24 via the data transmitting/receiving unit 23 in a way that carries the command on carrier waves, then receives and demodulates the card ID transmitted as carried on the carrier waves by the ID card 3 in response to the card ID readout command, and inputs the card ID to the CPU 24 via the data transmitting/receiving unit 23.

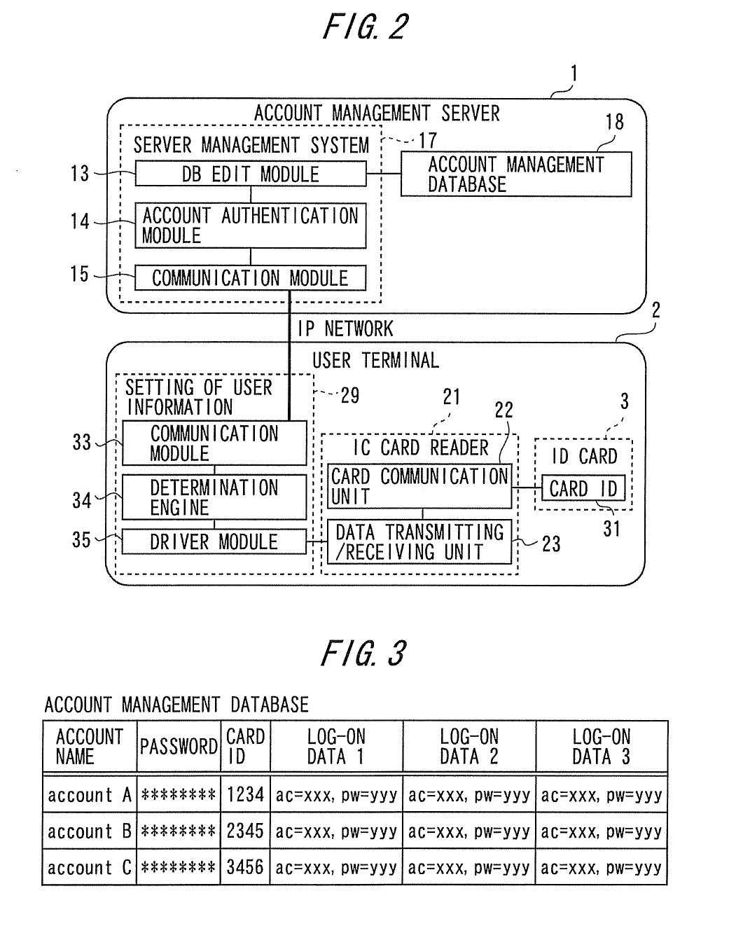

The user information setting program 29 stored in the hard disk 20 is, as illustrated in FIG. 2, constructed of a plurality of modules such as a communication module 33, a determination engine 34 and a driver module 35, and these modules are cached on the RAM 27, whereby the CPU 24 exhibits functions equivalent to the respective modules.

For example, the driver module 35, which is a driver program for driving and controlling the IC card reader 21, instructs the IC card reader 21 to transmit the ID command described above and gets the CPU 24 to exhibit the function of reading the card ID 31 from the ID card 3.

Moreover, the determination engine 34, gets the CPU 24 to execute the function of determining that the card is usable, if only the card ID is successfully read and the readout card ID satisfies a predetermined format.

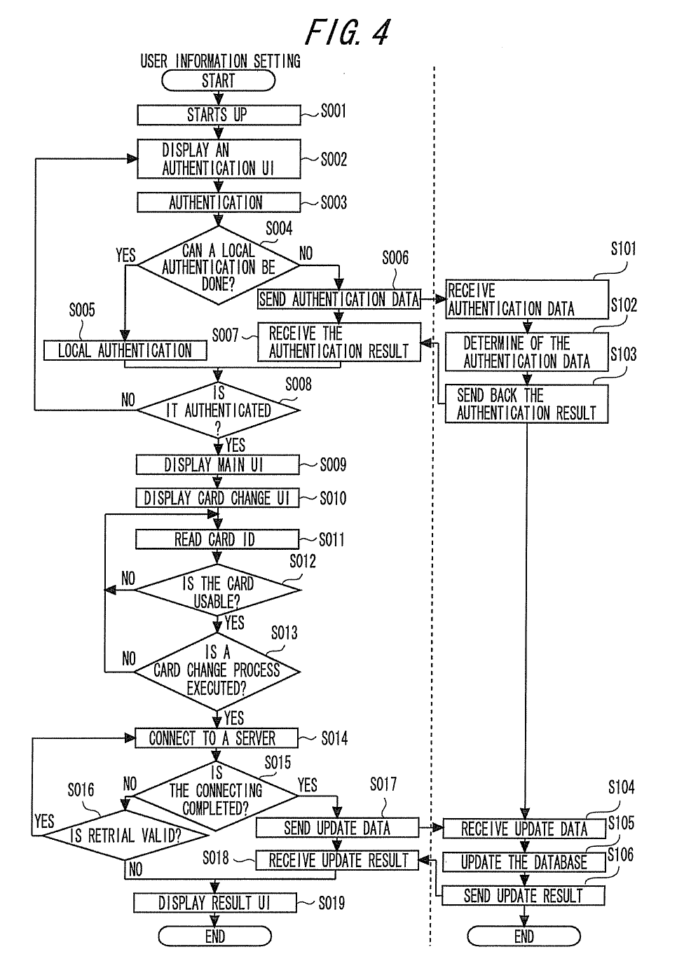

Further, the communication module 33 includes a driver program for driving and controlling the network card 28, and gets the CPU 24 to execute a function of performing the communications with the account management server 1, transmitting an authentication request and an update request for updating the account management DB 18 to the account management server 1 and receiving an authentication result and an update result. A function of the whole user information setting program 29 will be described in detail later on with reference to a flowchart in FIG. 4.

Next, the account management server 1 administered by the service provider is a server computer which retains and manages the account information about the users who signed the contracts about the variety of services with the service provider, authenticates the user based on the account information in response to the authentication request given from the user, and sends back the log-on data as a response for the variety of services to the authenticated user.

The account management server 1 is the server computer having the normal configuration and is constructed of, as main hardware components, a CPU 10, a RAM 11, a network card 12 and a hard disk 16, which are connected to each other via the bus B.

The CPU 10 is a central processing unit which executes processes based on a program.

The RAM 11 is a main storage device on which the program from the hard disk 16 and an operation area used for the CPU 10 to execute the processes is developed.

The network card 12 is a communication device (corresponding to responding section) which terminates the network NW and controls the data communications with the network NW.

The hard disk 16 is a storage device stored with an unillustrated operating system (OS), a variety of programs such as a WWW server program and various types of CGI (Common Gateway Interface) programs. Various items of data stored in the hard disk 16 include an account management database 18 for managing the account information on the individual users who previously signed the contracts with the service provider administering the account management server 1.

FIG. 3 is a table showing a data structure of the account management database 18. As illustrated in FIG. 3, the account management database 18 is organized by records associated with the individual users. Then, each record consists of an “account name” field for recording an account name (a user ID, i.e., individual identifying information) assigned to each associated user, a “password” field for recording a password combined with the account name, a “card ID” field for recording the card ID of the ID card 3 held by the user for the service provided by the service provider, and a plurality of “log-on data” fields (only three fields are illustrated in FIG. 3) for storing plural pieces of log-on data (of which number is same as the services about which the user signed the contracts with the service provider) for logging on the variety of services provided by the service provider.

Further, the variety of programs stored in the hard disk 16 include a server management system program 17 which makes the CPU 10 execute the individual authentication process and accessing to update the account management database 18 the account management database 18 by linking up with the user information setting program 29 executed by the CPU 24 of the user terminal 2. The server management system program 17 is, as illustrated in FIG. 2, structured by a plurality of modules such as a communication module 15, an account authentication module 14 and a DB edit module 13, and these modules are cached on the RAM 11, whereby the CPU 10 exhibits functions equivalent to the respective modules.

For example, the communication module 15 includes a driver program for driving and controlling the network card 12, and gets the CPU 10 to execute a function of performing the communications with each user terminal 2, receiving the authentication request and the account information update request from the user terminal 2, and transmitting the authentication result and the update result.

Moreover, the account authentication module 14 makes the CPU 10 execute a function of referring to the account management database 18, based on the authentication result received from the communication module 15, determining whether or not the information (the card ID (or set of the card ID and the password), or a set of the account name and the password) contained in the authentication request is registered in the account management database 18, then generating a determination result (containing the respective pieces of log-on data if requested for the authentication with the card ID (or set of the card ID and the password), or a set of the account name and the password) and instructing the communication modules 15 transmit the determination result.

Further, the DB edit module 13 makes the CPU 10 execute a function of updating, if the account authentication module 14 determines that the authentication based on the set of the account name and the password gets successful, the account management database 18 on the basis of the update request.

### <Data Processing Flow>

The following are explanations of a process actualized by the CPU 24 which reads the user information setting program 29 stored in the hard disk 20 and of a process actualized by the CPU 10 which reads the server management system program 17 stored in the hard disk 16 on the thus-configured user terminal 2.

### [Process at Normal Time]

To start with, when the user holding the ID card 3 stored with the card ID recorded in any one of the records in the account management DB 18 starts up the program for executing the service requiring any one piece of log-on data registered in the record, the program displays a request message for reading the card ID from the ID card 3 and for inputting the password on the display 25. When the user sets the ID card 3 into the IC card reader 21 in response to this request message, the card ID is read from the ID card 3, and the password is inputted by operating the input device 26, so that the CPU 24 generates the authentication data based on the card ID and the password and transmits the authentication data to the account management server 1.

Then, the CPU 10 of the account management server 1 checks whether or not the set of the card ID and the password contained in the received authentication data is registered in the account management DB 18, and if registered in any one of the records, the CPU 10 reads each piece of log-on data registered in the same record, then generates the authentication result information containing the log-on data, and sends back the authentication result information as a response to the requester terminal 2 (which corresponds to responding section).

Then, on the requester terminal 2, the log-on data requested by the program is transferred to the program from the received authentication result information, thereby executing the program-based service.

Note that the authentication data is generated as a combination of the card ID and the password in the example given above, however, unless any hindrance occurs with somewhat low security level, the password may be retained previously in the ROM area 31 within the ID card 3 and may also be originally made unnecessary.

As far as the user holds the ID card 3, the user can receive the desired service by carrying out the authenticating operation.

### [Process When Card is Lost or Damaged]

In this connection, if the user loses or damages the ID card 3, the user starts the process illustrated in a flowchart of FIG. 4 by inputting a predetermined command for starting up the user information setting program 29.

In first step S001 after starting this process, the CPU 24 executing the user information setting program 29 (the CPU 24 and the program 29 in combination will hereinafter be simply referred to as the “user information setting program 29”) starts up the module needed for updating the account management DB 18.

In next step S002, the user information setting program 29 displays an unillustrated authentication UI (User Interface) screen on the display 25. This authentication UI screen contains text boxes for respectively inputting the account name and the password of the user, and an “authentication” button.

In subsequent step S003, the user information setting program 29 stands by till the user operates the “authentication” button after setting the character strings in the respective text boxes on the authentication UI screen by operating the input device 26. Then, when the “authentication” button is operated in a state where the character strings are set in the respective text boxes on the authentication UI screen, the character stings set in the respective text boxes are fetched as the account name and the password (which corresponds to individual identifying information acquiring section), and the process advances to S004.

In S004, the user information setting program 29 determines whether the local authentication can be done or not. The local authentication is an authentication process which is executed based on whether or not, if the account name and the password are registered in an area that can not be previously accessed directly by the user on the hard disk 20 of the user terminal 2, the tuple of the account name and the password such as this is coincident with a tuple of two character strings set in the respective text boxes on the authentication UI screen. Then, if possible of making the local authentication, the user information setting program 29, in S005, executes the local authentication, then determines whether or not the set of the account name and the password is coincident with the set of the two character strings set in the respective text boxes on the authentication UI screen, and advances the process to S008.

Whereas if not possible of making the local authentication, in S006, the user information setting program 29, with the character string set in the text box for the account name on the authentication UI screen being defined as the account name and with the character string set in the text box for the password being defined as the password, generates the authentication data containing these account name and password, and transmits the authentication data to the account management server 1. Upon completion of S006, the user information setting program 29 waits for a response from the account management server 1 in next step S007.

On the other hand, in the account management server 1 receiving the authentication data, in S101, the CPU 10 starts up the server management system program 17, and the CPU 10 executing the server management system program 17 (the CPU 10 and the program 17 in combination will hereinafter be simply termed the “server management system program 17”) receives the authentication data.

In next step S102, the server management system program 17 makes the determination about the authentication data received in S102. To be specific, the server management system program 17 checks whether or not the set of the account name and the password contained in the authentication data is registered in any one of the records in the account management DB 18. Then, the server management system program 17, if the set of data is registered in any one of the records, determines that the authentication gets successful but determines, whereas if not registered, that the authentication gets into a failure.

In subsequent step S103, the server management system program 17 sends back the authentication result, as a response, that is the result of the determination made in S102 to the user terminal 2 as the authentication requester. Note that the authentication result showing the success in the authentication contains the card ID in the same record as the record containing the account name and the password.

In the user terminal 2, when receiving the authentication result in S007, the user information setting program 29 advances the process to S008.

In S008, the user information setting program 29 checks, based on the determination about the authentication data in S005 or the content of the authentication result received in S007, whether the authentication gets successful or not. Then, if the authentication gets into the failure, the process is looped back to S002.

Whereas if the authentication gets successful, the user information setting program 29 advances the process to S009 from S008.

In S009, the user information setting program 29 displays the main UI screen illustrated in FIG. 5 on the display 25. The main UI screen contains a card change button 40. When the card change button 40 is operated by the user's operating the input device 26, the user information setting program 29 advances the process to S010 from S009.

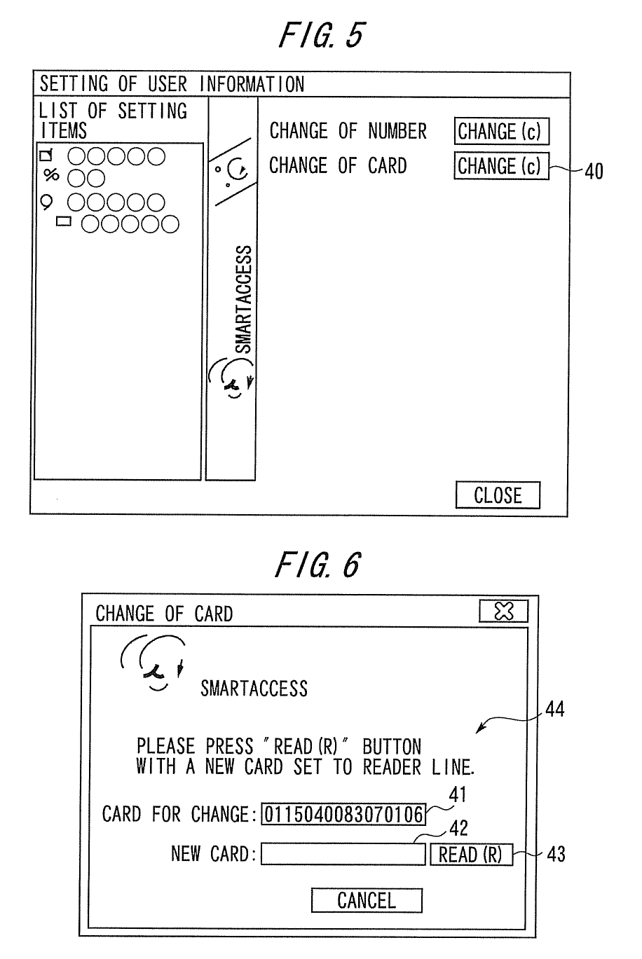

In S010, the user information setting program 29 displays a card change UI screen illustrated in FIG. 6 on the display 25. The card change UI screen contains an old card ID display box 41 for displaying the card ID contained in the authentication result received in S018, a new card ID display box 42 for displaying the card ID of the post-change ID card, a “read” button 43 and a message 44 purporting that the new ID card is set in and read by the IC card reader 21. It is expected that the user seeing the card change UI screen sets another ID card (i.e., the ID card having the same construction as the lost or damaged ID card has) based on the standard that supports the present authentication system and operates the “read” button 43. Another ID card used herein may also be, e.g., a card that has already been in use for a different application, which is registered in a different service provider. Upon completion of Solo, the user information setting program 29 advances the process to S011.

In S011, the user information setting program 29 stands by till the user operates the “read” button 43, then, when the “read” button 43 is operated, sends a card ID readout command to the IC card reader 21 and gets the IC card reader 21 to read the card ID (which corresponds to reading section).

In next step S012, the user information setting program 29 checks whether or not the card ID in a predetermined format is read as a result of reading the card ID in S011. Then, if the card ID in the predetermined format is not read, an assumption is that the usable ID card is not set in the IC card reader 21, and hence the process is looped back to S011. Whereas if the card ID in the predetermined format is read, it is assumed that the usable ID card is set in the IC card reader 21, and therefore the process proceeds to S013.

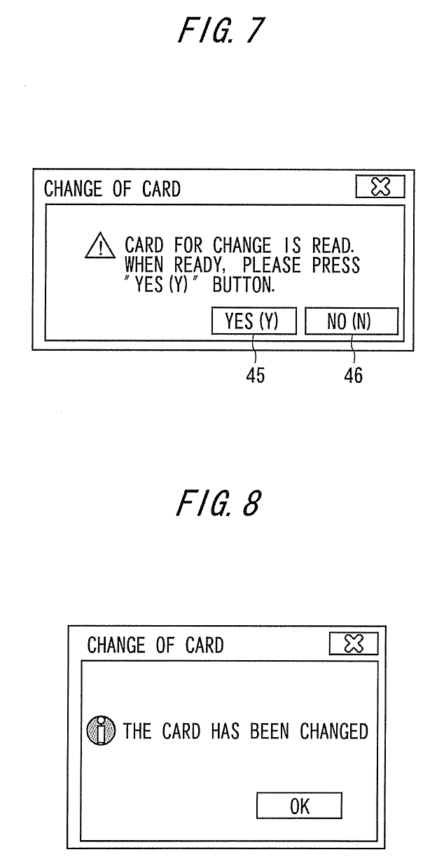

In S013, the user information setting program 29 displays a card change execution screen illustrated in FIG. 7. The card change execution screen contains, as illustrated in FIG. 7, a “Yes” button 45 and a “No” button 46. Then, if the “No” button 46 is operated, the process is looped back to S011. By contrast, if the “Yes” button 45 is operated, the user information setting program 29 advances the process to S014 from S013.

In S014, the user information setting program 29 connects with and logs on the account management server 1. In the case of having already completed the processes in S006-S007, however, this implies that the user information setting program 29 has already logged on the account management server 1, and hence, so far as the same session is kept, the operation skips over S014.

In next S015, the user information setting program 29 checks whether the connection with the account management server 1 is completed or not. Then, if the connection is not completed, the user information setting program 29 checks in S016 whether retrial is valid or not. For example, if a retrial count has an upper limit, it is checked whether the retrial count is within the upper limit or not. Then, the user information setting program 29 loops back the process to S014 if the retry is valid, but advances the process to S019 whereas if the retrial is invalid.

On the other hand, in the case of determining in S015 that the connection has been completed, the user information setting program 29 transmits in S017 update data (update information) containing the account name inputted in S003 and the card ID read in S011 to the account management server 1 (which corresponds to transmitting section). Upon completion of S017, the user information setting program 29 waits for a response from account management server 1 in next step S018.

On the other hand, in the account management server 1 receiving the update data, the server management system program 17, when receiving the update data in S104, advances the process to S015. In S015, the account management server 1 overwrites the card ID in the same update data to the “card ID” field in the record associated with the account name in the update data received in S104 in the account management database 18, thus updating the account management database 18 (which corresponds to update section).

In next step S106, the server management system program 17 sends back the update result as a response to the requester user terminal 2.

On the user terminal 2, when receiving the update result in S018, the user information setting program 29 advances the process to S019.

In S019, the user information setting program 29 displays a result UI screen on the display 25. FIG. 8 illustrates the result UI screen in the case of receiving the update result in S018, and, as illustrated in FIG. 8, the result UI screen contains a message purporting that the card has been changed. By contrast, when determining S016 that the retrial is invalid, it follows that the result UI screen containing an error message is displayed. When completing S019, the user information setting program 29 terminates all of the processes.

### Operation in Embodiment

The user signs the contract for receiving the service with the service provider and, when the card ID of the ID card (A) serving as the authentication device for the service is registered together with the user's own account ID and password in the account management database 18 of the account management server 1 administered by the service provider, can get the user's own user terminal 2 to execute the service by use of the ID card (A). In this case, the procedures of authenticating the individual by employing the ID card (A) are as explained in the paragraph “Process at Normal Time” described above, and hence its description is omitted.

In case the user loses the ID card (A) and if the user possesses another ID card (B) (i.e., the ID card embedded with an IC chip to which the card ID in the same format is written) based on the same standard as the ID card (A) at hand, the ID card (B) can be diverted as a new authentication device for authenticating the individual for executing the service. The procedures for this diversion are as explained in the paragraph “Process When Lost and Damaged”, and therefore the description thereof is omitted. As a result of this process, a value entered in the “card ID” field in the record containing the description of the account name of the relevant user in the account management database 18 is rewritten into the card ID (B) of the ID card (B) from the card ID (A) of the ID card (A). As a result, thereafter, the user can use the ID card (B) as the authentication device for authenticating the individual for executing the service in the same way as the original ID card (A) can be used.

Note that if the ID card (A) is originally used also for the user's identity authentication for the service (such as a credit card service, a commuter's pass service in the transportation facilities and an electronic money service) executed on a different authentication terminal without utilizing the user terminal 2 provided by (linked to) the service provider, it follows that the post-change ID card (B) is used for the user's identity authentication for the service such as this. Note that in this case, the authentication terminal executing the service performs the same function as that of the user terminal 2 in the “Process at Normal Time” described above.

Accordingly, even if the original ID card (A) is lost or damaged in a remote place, as far as the user possesses the user terminal 2 including both of the IC card reader 21 connectable to the network NW and installed with the user information setting program 29 and another ID card (B) having the same standard as the ID card (A), the user can utilize the ID card (B) as the new authentication device similarly, as if a new ID card is issued only through the simple procedure such as connecting the user terminal 2 with the account management server 1 and executing the processes described above.

Therefore, according to the embodiment, such a time-consuming operation is not required as to search for a contact with the service provider in the remote place and receive the ID card reissued from the service provider, and, in addition, without any troublesome operation of undergoing issuance of a one-time password each time the service is utilized, it is feasible to receive the service from the service provider absolutely in the same way as before.

Furthermore, according to the embodiment, the card ID of the lost ID card (A) becomes immediately invalidated, and hence, even when the third party tries to receive the service unlawfully, the authentication on the account management server 1 results in the failure, the third party can not obtain the log-on information needed for executing the service. Besides, the third party, if the account name and the password (especially the password) of the user are unknown, can neither undergo the authentication from the account management server 1 nor therefore updates the account management DB 18 as a spoofed user. Hence, the embodiment has no inferiority in terms of the security to the prior arts.

It should be noted that the combination of the user terminal 2 and the ID card 3 is not limited to the combination of the personal computer and the non-contact type card, and the former device may be a mobile information terminal, while the latter device may be a contact type card. For example, the user terminal 2 can be replaced by a mobile phone, and the ID card 3 can be replaced by the SIM card loaded into the mobile phone. In this case, it is considered that the IC card reader 21 involves using a contact type card reader (card slot, card socket).

Further, the authentication device can be, without being limited to the configuration of the IC card, all types of authentication devices such as a USB authentication key.

Moreover, the authentication of the identity can be utilized for all of the services. For example, if the system for instantaneously authenticating the individual between the server and the user terminal is utilized for the electronic money service and the commuter's pass service in the transportation facilities in addition to the credit card service described above, the present invention can be applied thereto. Moreover, the application objects (schemes) of the present invention include opening/closing a security gate that does not necessarily come under the categories of the services and the identity authentication for a simple inquiry about the identity, which does not involve the service.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. An authentication system comprising: an authentication server device authenticating an identity based on unique device identifying information received from an authentication terminal capable of reading the unique device identifying information from an authentication device; and a user terminal,
wherein said user terminal comprises:
a reading section which reads a unique device identifying information from said authentication device;
an individual identifying information acquiring section which acquires individual identifying information of a user; and
a transmitting section which transmits update information containing the device identifying information and the individual identifying information to said authentication server device,
and wherein said authentication server device comprises:
a storage device stored with the individual identifying information and the device identifying information in a way that these items of information are associated with each other; and
an update section which updates, with the device identifying information in the update information, the device identifying information stored in said storage device in the way of being associated with the individual identifying information in the update information received from said user terminal.

2. An authentication system according to claim 1, wherein said authentication terminal is integral with said user terminal.

3. An authentication system according to claim 1, wherein said authentication device is an ID card stored with the unique device identifying information.

4. An authentication system according to claim 1, wherein said authentication terminal is a device executing a service requiring log-on information,
said storage device is stored with the log-on information in the way of being associated with the individual identifying information and the device identifying information, and
said authentication server reads the log-on information stored in said storage device in the way of being associated with the device identifying information received from said authentication terminal, and sends back the log-on information as a response to said authentication terminal.

5. An authentication server device authenticating an identity based on unique device identifying information received from an authentication terminal capable of reading the unique device identifying information from an authentication device, comprising:
a storage device stored with individual identifying information of a possessor of an authentication device and device identifying information of said authentication device;
a responding section which sends back an authentication result as a response on the basis of information that the device identifying information received from said authentication terminal is stored in said storage device; and
an update section which updates, when receiving update information containing the device identifying information and the individual identifying information from a user terminal capable of reading the unique device identifying information from said authentication device and acquiring individual identifying information of a user, the device identifying information stored in said storage device in the way of being associated with the individual identifying information in the update information with the device identifying information in the update information.
